(19) United States
(12) Patent Application Publication
(10) Pub. No.: US 2007/0148511 A1
(43) Pub. Date: Jun. 28, 2007

(54) VOLTAGE TRANSDUCER FOR A FUEL CELL

(76) Inventor: CHUN-CHIN TUNG, Chupei (TW)

Correspondence Address: G. LINK CO., LTD., 3550 BELL ROAD, MINOOKA, IL, 60447, US

(21) Appl. No.: 11/616,006

(22) Filed: Dec. 25, 2006

(30) Foreign Application Priority Data
Dec. 28, 2005 (TW) 094222858

(51) Int. Cl. H01M 8/04

(52) U.S. Cl. 429/23

(57) ABSTRACT

A voltage transducer for a fuel cell is a device to control steady outputs of voltage and current by means of electronic circuit, which is capable of regulating instantaneous voltage and current at the time of converting output of a fuel cell to a load for the afterward circuit stages being operated under a normal working voltage. That is, the electronic circuit performs and changes characteristic curves of the fuel cell and the characteristic curves are to illustrate changes of the voltage and current of the fuel cell while a load is connected to the fuel cell externally.

### BACKGROUND OF THE INVENTION

1. Field of the Invention

The present invention is related to a device for controlling steady outputs of voltage by means of electronic circuit, which is capable of converting the outputs of a fuel cell and regulating instantaneous voltage and current during loading for the subsequent circuits working under a normal operational voltage.

2. Brief Description of the Related Art

The working characteristics of a fuel cell learned from FIG. 1 that when the fuel cell is connected to an external load, the instantaneous voltage has a drop called overshoot phenomenon. The overshoot phenomenon results from the external load affecting output current of the fuel cell so that there is an uncertain and unstable voltage at duration from occurring the voltage drop till reaching a steady state voltage. Hence, if output voltage of the fuel cell at the duration is less than rated driving input voltages of the subsequent stages, the subsequent circuit is incapable of working normally. When the fuel cell is connected to an external load, the current is reached to a steady current corresponding to the load from 0 ampere. However, the voltage does not change along with change of the current and produces the overshoot phenomenon. As the foregoing, the overshoot voltage is less than the steady operational voltage of the subsequent circuit. Further, there is a time difference and a voltage difference before the voltage reaches a steady voltage from a rated voltage. A slope of the voltage difference with respect to the time difference is influenced by the external load. The preceding voltage change is determined by the load corresponding to the current of the fuel cell but the overshoot resulting from the instantaneous change of the voltage influences the normal work of the subsequent driving devices.

### SUMMARY OF THE INVENTION

Accordingly, an object of the present invention is to provide a voltage transducer for a fuel cell and the voltage transducer provides a circuit device to control the current of the fuel cell for offering a steady voltage output and allowing the circuit to work effectively.

Another object of the present invention is to provide a condensation device for a fuel cell in which a turnabout path is defined to increase heat dissipating surface area for the gas with high heat and humidity such that cooling effect is promoted greatly.

In order to achieve the preceding object, a voltage transducer device for fuel cell according to the present invention provides an electronic circuit performs and changes characteristic curves of the fuel cell and the characteristic curves are to illustrate change of the output voltage of the fuel cell along with the current of a load while the fuel cell is connected to the load externally. The electronic circuit includes an inductor, a comparator, a field effect transistor (FET) or bipolar junction transistor (BJT), and a chip control circuit. The output voltage of the fuel cell compares with a reference voltage in the comparator such that the comparator sends out an electronic signal in case of the output voltage being less than the reference voltage and the electronic signal is processed with the chip control circuit so as to control a switch of the FET or BJT. Once the switch is actuated, the output current of the fuel cell can be adjusted and output currents of different stages can be obtained based on different reference voltages. Further, the number of the reference voltages and the switching time of the respective stage can be obtained by means of the conventional or automatic detection way. Alternatively, a secondary cell is parallel to the load end to maintain the required power at the load end at a steady value.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a graph illustrating characteristic curves of voltage and current with respect to time for the conventional fuel cell under load;

FIG. 2 is a block diagram of a voltage transducer for a fuel cell according to the present invention;

FIG. 3 is a voltage converting circuit diagram of a voltage transducer for a fuel cell according to the present invention; and

FIG. 4 is a graph illustrating characteristic curves of voltage and current of a fuel cell with respect to time after being converted with the voltage transducer according to the present invention.

### DETAILED DESCRIPTION OF THE INVENTION

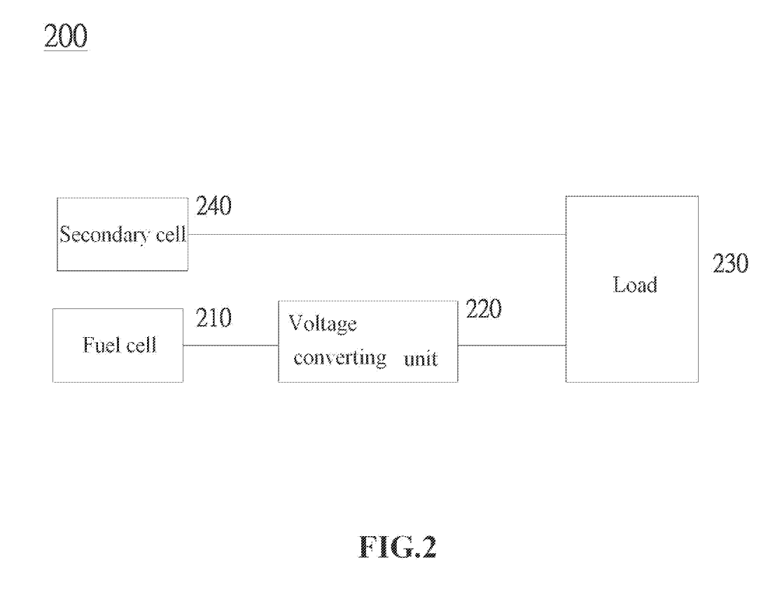

Referring to FIG. 2, a block diagram 200 of a voltage transducer for a fuel cell according to the present invention is illustrated. The voltage transducer includes a fuel cell 210, a voltage converting unit 220, a load 230 and a secondary cell 240. The fuel cell 210 is a power supply device and power thereof is generated with electrochemical reaction of hydrogen fuel and oxygen fuel. Taking direct methanol fuel cell as an example, the power is generated with the methanol fuel and oxygen performing electrochemical reaction. The voltage converting unit 220 operates with voltage conversion means and current limiting means, that is, voltage output of the fuel cell 210 is converted to a specific voltage output and current output of the fuel cell 210 is limited to a value less than a specific current. The load device 230, which is an electronic device, is employed to consume the power from the fuel cell 210. The secondary cell 240 is a chargeable cell to compensate insufficient power of the fuel cell 210. Further, the voltage converting unit 220 is capable of producing a relative current corresponding to the load device 230 by a current limiting means to lessen over voltage response of the fuel cell 210 and stabilize subsequent operation of circuit.

Referring to FIG. 2, the fuel cell 210 electrically connects with the voltage converting unit 220 to allow the power of the fuel cell 210 being sent to the voltage converting unit 220. Another output end of the voltage conversion unit 220 is electrically connected to the load device 230. The rated voltage required by the load device 230 is a steady voltage through the voltage conversion unit 220. The load device 230 further electrically connects with the secondary cell 240 such that the power required by the load device 230 can be compensated with the secondary cell 240 once insufficient power is supplied by the fuel cell 210.

The implementation of voltage conversion means can be performed with one of the following means: booster circuit means, bucking circuit means and booster with bucking circuit means (SEPIC or ZELTA). The booster circuit means is capable of converting the output voltage of the fuel cell to higher output voltage. The bucking circuit means is capable of converting the output voltage of the fuel cell to lower output voltage. The booster with bucking circuit means is capable of converting the output voltage of the fuel cell to higher output voltage or to lower output voltage selectively.

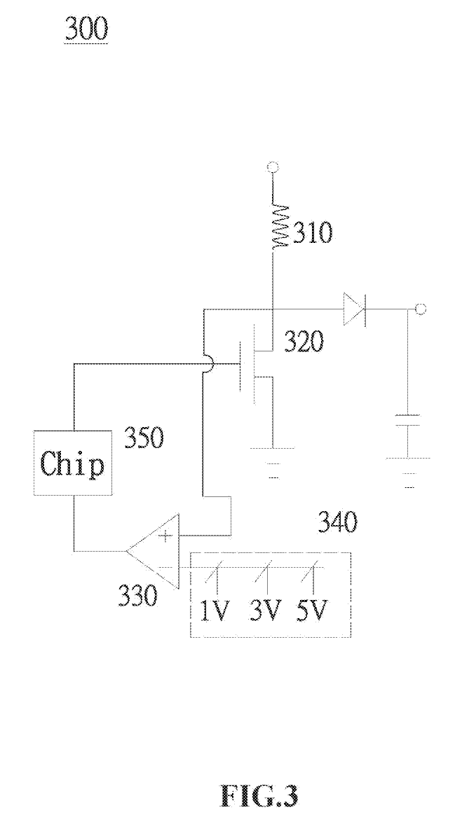

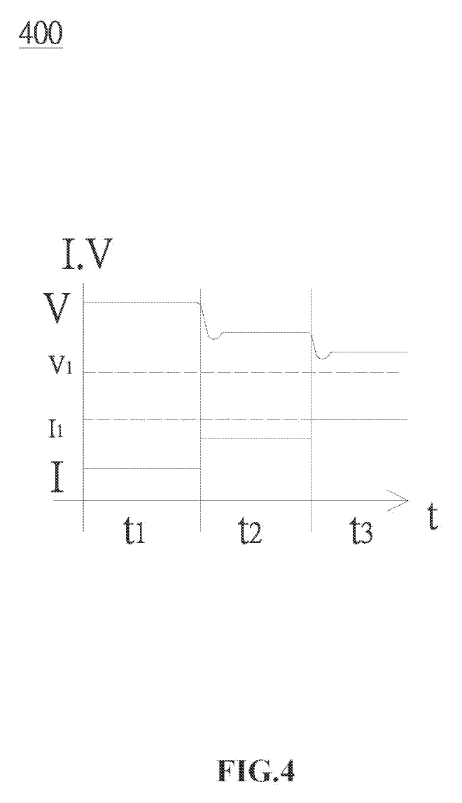

Referring to FIG. 3, the voltage converting circuit 300 is illustrated. The preceding voltage conversion unit converts the voltage and limits the current by means of a circuit. A preferred embodiment of the voltage converting circuit 300 includes an inductor 310, a field effect transistor (FET) 320, a voltage comparator 330, a reference voltage circuit 340 and a chip circuit 350. The voltage converting circuit 300 shown in FIG. 3 is a booster circuit and the principle of actuation is in that once FET 320 is ON and the current of the fuel cell acts the inductor 310, an ON-resistor R_{DS(ON)} of the FET 320 and the inductive current produce an ON-voltage drop V_{RDS(ON)} to compare with the reference voltage circuit 340 in the voltage comparator 330. A compared result is sent to the chip circuit 350 to control ON and OFF of the FET 320. That is, when V_{RDS(ON)} is lower than the voltage offered by the reference voltage circuit 340, the FET 320 is open and when V_{RDS(ON)} is higher than the voltage offered by the reference voltage circuit 340, the FET 320 is closed and a reversed inductive potential is produced by the inductor. Accordingly, a characteristic curve shown in FIG. 4 is obtained. In other words, when the reference voltage is located at the first stage switch voltage, the voltage from the fuel cell compares with the comparator during passing through the voltage converting circuit. In case of the comparative reference voltage being less than V_{RDS}(_{ON}), a steady current is output and in case of the comparative reference voltage being more than V_{RDS}(_{ON}), the electronic switch is off. When the reference voltage is located at the second stage switch voltage, V_{RDS(ON)} compares with the reference voltage again and the current from the fuel cell is limited at a specific value. Hence, in order to operate effectively, at least two stages of reference voltages are required to complete limitation of current.

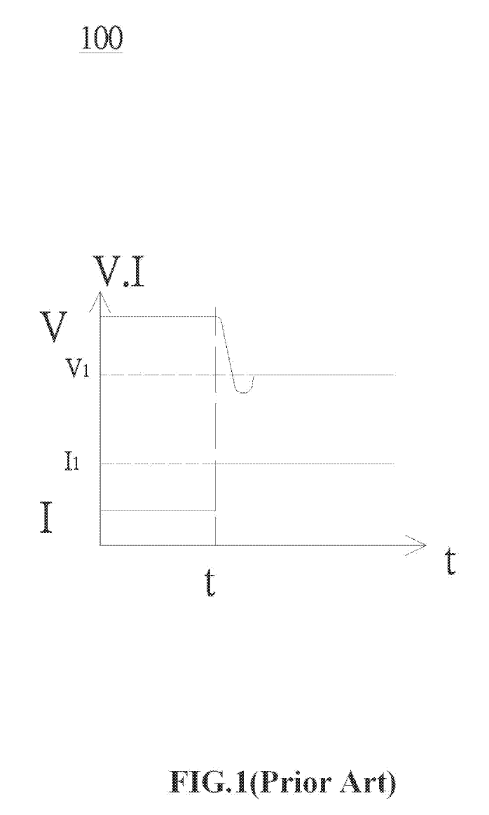

Referring to FIG. 4, a graph 400 showing the current and voltage characteristic curves after being converted with the voltage transducer according to the present invention is illustrated. It can be seen in the characteristic curves that at the time of the load being connected, the current rises instantaneously and the voltage drops instantaneously. Under this circumference, the current value is less than the current value being supposed to be corresponding to the load during time t2 first instead of jumping to the current value corresponding to the load immediately. The reference voltage with time t2 is controlled by the reference voltage circuit so that the reference voltage becomes lower than the steady operation voltage of the last stage without any instantaneous drops. The reference voltage switches to the next reference voltage after the time duration t2 and a current value I1, which corresponds to the load, is provided at the time duration t3. Further, the reference voltage drops to a steady voltage VI as well. Although it is unavoidable to have the overshoot of voltage in the process of conversion, the voltage converted by the voltage transducer is still higher than working voltage for the subsequent stage being capable of working normally. Anther embodiment of the present invention is an automatic voltage transducer. The voltage and current characteristics of the load 230 corresponding to the fuel cell are utilized to obtain change rates formed by voltage difference with respect to time difference as shown in FIG. 1 such that the reference voltage can be adjusted automatically to reach an acceptable number of current stages.

The preceding current limiting means includes determination of load and the determination of load is to determine load size in accordance with a voltage response of the fuel cell corresponding to power demand of the load and to adjust voltage value of the required reference voltage and number of stages based on the load size for avoiding excessive overshoot of the voltage response.

Each of the current limits of different stages is preferable to last after the end of temporary response of the voltage response thereof.

While the invention has been described with referencing to preferred embodiments thereof, it is to be understood that modifications or variations may be easily made without departing from the spirit of this invention, which is defined by the appended claims.

What is claimed is:

1. A voltage transducer for a fuel cell comprising:
a fuel cell supplying a voltage to a load end; and
a voltage converting unit further comprising a voltage converting means and a current limiting means;
wherein the fuel cell electrically connects with voltage converting unit and outputs a specific voltage via the voltage converting unit.

2. The voltage transducer for a fuel cell as defined in claim 1, wherein the voltage converting unit further comprises:
an inductor;
an electronic switch controlling output being on and off;
a voltage comparator comparing an input with a reference voltage;
a reference voltage circuit for controlling and selecting a reference voltage and a switching time; and
a chip control circuit for driving On and Off of the electronic switch;
wherein the inductor, the electronic switch, the voltage comparator, the reference voltage circuit and the chip control circuit constitute the voltage converting means and the current limiting means.

3. The voltage transducer for a fuel cell as defined in claim 2, wherein the electronic switch is an electronic component selected from a field effect transistor (FET) and a transistor.

4. The voltage transducer for a fuel cell as defined in claim 2, wherein reference voltage includes voltages of two stages.

5. The voltage transducer for a fuel cell as defined in claim 4, wherein the current limiting means is to determine load size in accordance with a voltage response of the fuel cell corresponding to power demand of the load and to adjust voltage value of the required reference voltage and number of stages based on the load size.

6. The voltage transducer for a fuel cell as defined in claim 2, further comprises a secondary cell.

7. The voltage transducer for a fuel cell as defined in claim 6, wherein the secondary cell is a Lithium cell.

8. The voltage transducer for a fuel cell as defined in claim 1, wherein the voltage converting means is one of a booster circuit, a bucking circuit and a booster with bucking circuit.

9. The voltage transducer for a fuel cell as defined in claim 1, wherein an optimum time duration of each of stages of the current limiting means is to last after the end of temporary response of voltage response thereof.
